(19) United States
(12) Patent Application Publication
(10) Pub. No.: US 2026/0138776 A1
(43) Pub. Date: May 21, 2026

(54) Packaged Dry Pet Food System

(71) Applicant: Consumers Supply Distributing LLC, North Sioux City, SD (US)

(72) Inventors: Keith Rees, North Sioux City, SD (US); Corey Weitzel, North Sioux City, SD (US); Eric Meyer, North Sioux City, SD (US)

(21) Appl. No.: 19/396,698

(22) Filed: Nov. 21, 2025

Related U.S. Application Data
(60) Provisional application No. 63/723,470, filed on Nov. 21, 2024.

(51) Int. Cl. B65D 5/48; A23K 10/20; A23K 10/22; A23K 10/30; A23K 10/35; A23K 20/147; A23K 20/158; A23K 50/42

(52) U.S. Cl. CPC B65D 5/48; A23K 10/20; A23K 10/22; A23K 10/30; A23K 10/35; A23K 20/147; A23K 20/158; A23K 50/42

(57) ABSTRACT

A system for a packaged dry pet food is provided. The system includes a container having a plurality of individual packages of dry pet food. The dry pet food contained within each of the individual packages comprises between 80 to 99 percent by weight of the same ingredients and an equal percentage by weight of a protein. At least a first package contains a dry pet food of a first flavor, and at least a second package contains a dry pet food of a second flavor that is different from the first flavor.

### CROSS REFERENCE TO A RELATED APPLICATION

This application claims the benefit of provisional patent application U.S. App. No. 63/723,470, filed on Nov. 11, 2024 and entitled “Packaged Dry Pet Food System”, the entire contents of which are hereby expressly incorporated by reference into the present application.

### BACKGROUND OF THE INVENTION

### 1. Field of the Invention

The present invention relates to packaged dry pet food system and, more particularly, to a variety of independently packaged portions of dry pet food in a variety of flavors that share a substantial dietary nutritional profile and common ingredients that are provided in a common retail container. The present invention also relates to a method of manufacturing such a system.

### 2. Discussion of the Related Art

It is currently estimated that over 80 million dogs and 70 million cats are kept as pets in the United States. Caring for such a large number of domestic animals has generated a large pet care industry. A significant portion of that industry is directed to providing healthy and nutritious pet food. However, often dry pet food, i.e., kibble, is provided to pets routinely at all meals with limited or no variation. One of the key considerations in providing pets with a repetitive dry pet food diet is that switching foods may lead to digestive upset within the animal. While switching from one brand to another may present a sufficiently different ingredient formulation to cause undesirable digestive effects, even switching from one formulation to another within the same brand may have such undesirable effects due to differences between their respective nutritional panels. As such, many pet owners will simply keep their pet on the same type of food, to entirely avoid a potential problem.

If an owner does elect to switch their pet's dry food, often one will need to do so via a gradual transition, feeding a small amount of a new dry food along with the old food for a period of two to three weeks, if not longer, in order to avoid the undesirable result of digestive upset within the animal.

Additionally, unlike most wet pet food, dry pet foods are often sold in bulk packaging, such as bags of loose kibble weighing upwards of 12 pounds and often as large as 40 pounds. Such large packages deter the ability of the pet owner to provide dietary variety to their pet, as the owner's purchase of a large quantity of dry pet food obligates them to use that bulk bag of food (being one flavor) before spoilage or expiration.

An additional disadvantage of such traditional large portions, i.e., bulk packages, is that they are inconvenient for portable use. For example, when a pet owner travels and needs to bring a smaller supply of dry pet food with them, one would need to assemble a smaller portion of pet food in a separate package that is suitable for travel. Similarly, if a pet is temporarily staying away from the home, be it an overnight kennel, extended stay at a veterinarian, or pet daycare facility, pet food will need to be portioned and packaged from the bulk supply.

The shelf-life for a traditional large portion, i.e., bulk, package of dry pet food also drops rapidly after the package has been opened and exposed to atmosphere (humidity, air, microbes, etc.). When in its unopened package, a dry pet food may have on average a shelf-life of 12-18 months from the date of manufacture. However, that time period drops to 4-6 weeks after the package has been opened. This short window to consume the dry pet food before spoilage is yet another factor that inhibits pet owners that buy traditional large portion packages of dry pet food from providing a variety of flavor variations or options to their pet.

Pet owners today feel a greater connection to their pets and want them to be part of the family and treat them like family. Feeding one's pet the same food day in and day out is monotonous and does not allow for any variety in feeding. Even attempting to supplement a traditional dry food diet with the occasional different foods or table scraps can cause problems with dogs' digestive systems.

Thus, it would be desirable to provide an improved packaged dry pet food system that includes a variety of food flavors while maintaining a high degree of dietary/nutritional consistency and ingredient similarity amongst the different flavors. It is also desirable to provide an improved packaging system that includes a plurality of independently packaged dry pet foods flavors in relatively smaller portion sizes within a common retail container.

Such a system is unique in that it allows the pet owner to feel comfortable feeding their pet different flavors at each meal without the risk of undesirable digestion issues that often result from switching to different foods or different food flavors.

A new pet food concept that is unique to the market, which includes four different naturally flavored pet foods. Each pet food is 80 to 99% the same. The only variation between them is the external flavoring. All meat inclusions within the product of an equal weight percentage value, allowing any one of the meat inclusions to be moved to the front of the list on the ingredient panel or to be highlighted by natural flavorings without significantly altering the nutritional profile of the formula.

### SUMMARY OF THE INVENTION

In accordance with the first aspect of the invention, this need is satisfied by providing a container having a plurality of individual packages of dry pet food. The dry pet food contained within each of the individual packages comprises between 80 to 99 percent by weight of the same ingredients and equal percentages by weight of a protein, such as beef, pork and chicken. At least a first package contains a dry pet food of a first flavor, and at least a second package contains a dry pet food of a second flavor that is different from the first flavor.

A nonlimiting feature of this embodiment is to provide a system including individual packages that are easily transportable and allow the dry pet food to maintain longer shelf-life.

Accordingly, the system may include individual packages that comprise between 10 ounces and 7 pounds of dry pet food.

A nonlimiting feature of this embodiment is to provide a system in which the individual packages inhibit spoilage of the dry pet food contained therein.

Accordingly, the system may include individual packages that are formed of an airtight package wall.

A nonlimiting feature of this embodiment is to provide four flavors of dry pet food in each container.

Accordingly, the system may further include a third package containing a dry pet food of a third flavor that is different from the first and second flavor and fourth package containing a dry pet food of a fourth flavor that is different from the first, second and third flavors.

A nonlimiting feature of this embodiment is to provide a packaged dry pet food system in which a variety of proteins, such as beef, pork or chicken, may be listed as the top listed ingredient for any package of dry pet food in the container without modification to the dry pet food formulation.

Accordingly, the system may further include beef, pork, and/or chicken inclusions within the dry pet foods having equal weight percentage so as to appear at a top of the list on the ingredient panel in any order.

A nonlimiting feature of this embodiment is to provide a packaged dry pet food system of individual packages of dry pet food within the container that includes a variety of flavors.

Accordingly, the system may further include dry pet food having at least two flavors selected from a group including beef, cheese, chicken, fish, gravy, and barbecue.

A nonlimiting feature of this embodiment is to provide a packaged dry pet food system in which the container for the plurality of individual packages identifies the flavors of the individual packages of dry pet food.

Accordingly, the system may further include a box having a flip up lid with an internal indicium, such as a billboard presentation with each pet food flavor.

A nonlimiting feature of this embodiment is to provide a method for manufacturing a packaged dry pet food system according to the present invention. The method may include the steps of first forming a dry pet food having an equal percentage by weight of an animal protein. Then, flavoring at least a first portion of the dry pet food with a first flavor and at least a second portion of the dry pet food with a second flavor, while maintaining between 80 to 99 percent by weight of the same ingredients between the first and second portions. After flavoring, then packaging the first portion of the dry pet foods into a first package containing only the dry pet food with the first flavor and packaging the second portion of the dry pet foods into a second package containing only the dry pet food with the second flavor. Finally, combining the first package containing only the dry pet food with the first flavor and the second package containing only the dry pet food with the second flavor into a common retail box, such that the box includes a plurality of dry pet food flavors while maintaining between 80 to 99 percent by weight of the same ingredients between all dry pet food.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a perspective view of a packaged dry pet foods system constructed in accordance with an aspect of the present invention;

FIG. 2 is a block diagram of the system of FIG. 1;

FIG. 3 is a perspective view of another packaged dry pet foods system constructed in accordance with an aspect of the present invention;

FIG. 4 is a perspective view of yet another packaged dry pet foods system constructed in accordance with an aspect of the present invention;

FIG. 5 is a flow chart of a method of manufacturing the system of claim 1; and

FIG. 6 is an exemplary nutritional label for an individual package in a packaged dry pet foods system constructed in accordance with the present invention.

### DETAILED DESCRIPTION OF THE PREFERRED EMBODIMENTS

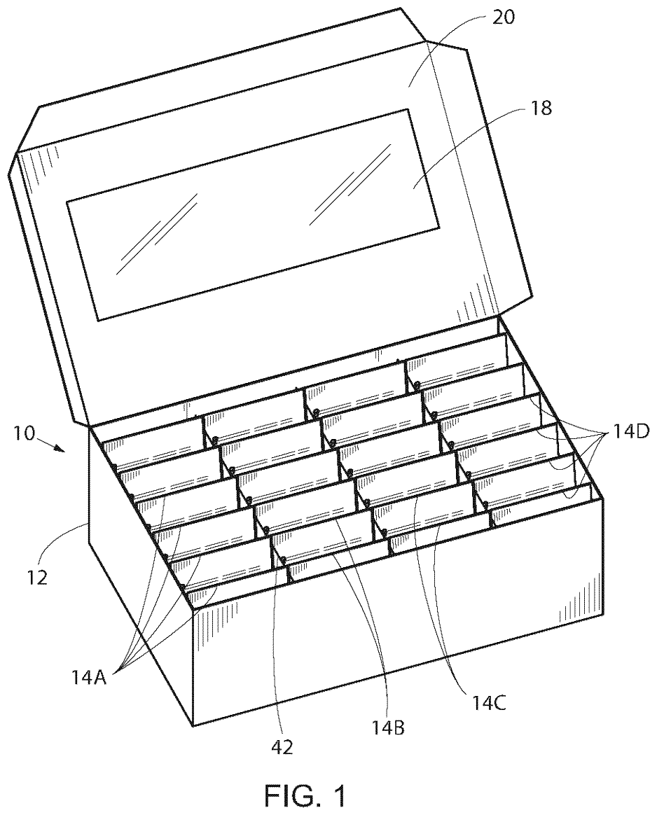

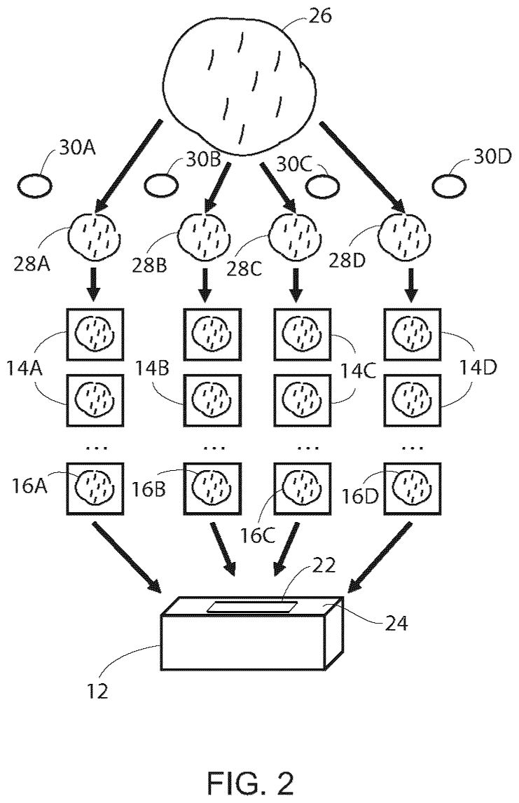

Referring now to FIGS. 1 and 2, and initially FIG. 1 in accordance with an aspect of the invention, a packaged dry pet food system 10 is illustrated and described in further detail below. The system 10 includes a container 12, such as a box, which is suited for retail sale. The container 12, includes a plurality of independent packages 14 of dry pet food 16. A plurality of flavors of dry pet food 16 are provided, identified herein as reference number 16A, 16B, 16C, 16D, etc. Each of the plurality of flavors of dry pet food 16 are contained within the plurality of independent packages 14 that correspond to their respective flavor of dry pet food 16, identified herein as reference number 14A, 14B, 14C, 14D, etc. In one embodiment of the system 10, as shown in FIGS. 1 and 2, the container 12 includes four (4) different flavors of dry pet food, 16A-16D, corresponding to different independent packages identified as 14A-14D respectively. In another configuration, the container 12 includes two (2) or more different flavors of dry pet food.

Still referring to FIG. 1, the packages 14A-14D, containing the different flavors of dry pet food 16A-16D, may be organized or identified in such a manner that a user, such as a pet owner, can select the package 14A-14D corresponding to the desired flavor of dry pet food 16A-16D of their choice. In one embodiment, the container 12 may include an indicium 18, such as a text and/or illustration located on an inner surface 20 of the container, for identifying the location of the different flavors of dry pet food 16A-16D, such as a billboard-style sign. Alternatively, or in combination with indicium 18, the individual packages 14A-14D may also include an indicium (not shown) such as a text and/or illustration identifying the flavor contained within the respective individual package 14A-14D. In addition to identifying the location of the different flavors of dry pet food 16A-16D in the interior of the container 12, an external indicium 22 is provided on an external surface 24 of the container 12 to facilitate retail sale of the container 12 and identify the plurality of different flavors of dry pet food 16A-16D contained therein. The system 10 may also include dividers 42 to separate each package 14 in the container 12.

Referring now to FIG. 2, a volume of dry pet food ingredients 26, i.e. kibble ingredients, are combined such that the contents thereof are homogeneously distributed throughout. In one embodiment of the system 10, the largest dry pet food ingredient 26, is one or more animal proteins or meats, otherwise referred to herein as a meat inclusion, such as including beef, pork and/or chicken. In one embodiment, the largest dry pet food ingredients 26, are at least two or more proteins, wherein the percentage weight of the two or more meats selected from the group are equal, within a fraction of one percent.

In an embodiment, in addition to an animal protein, the dry pet food ingredients 26 may also include one or more ingredients selected from the group including but not limited to brown rice, pearled barley, oat groats, bacon fat (preserved with mixed tocopherols), sweet potatoes, pumpkin, and sun-cured ground miscanthus grass.

In an embodiment, the dry pet food ingredients 26 may include each of: brown rice, pearled barley, oat groats, bacon fat (preserved with mixed tocopherols), sweet potatoes, pumpkin, sun-cured ground miscanthus grass, cheddar cheese powder, potassium chloride, choline chloride, chicory, dried aspergillus oryzae fermentation product, lecithin, Yucca schidigera extract, iron proteinate, zinc proteinate, glucosamine hydrochloride, chondroitin sulfate, copper proteinate, and manganese proteinate.

In an embodiment, the dry pet food ingredients 26 may also include a microbial additive selected from the group including but not limited to selenium yeast, dried Bacillus subtilis fermentation product, dried Bacillus coagulans fermentation product, dried Enterococcus faecium fermentation product, dried Lactobacillus acidophilus fermentation product, dried Lactobacillus casei fermentation product, and dried Lactobacillus plantarum fermentation product.

In an embodiment, the dry pet food ingredients 26 may also include a microbial additive including each of selenium yeast, dried Bacillus subtilis fermentation product, dried Bacillus coagulans fermentation product, dried Enterococcus faecium fermentation product, dried Lactobacillus acidophilus fermentation product, dried Lactobacillus casei fermentation product, and dried Lactobacillus plantarum fermentation product.

In an embodiment, the dry pet food ingredients 26 may include a nutritional supplement selected from a group including but not limited to vitamin e supplement, niacin supplement, calcium pantothenate, riboflavin supplement, biotin, vitamin a supplement, vitamin b12 supplement, thiamine mononitrate, pyridoxine hydrochloride, vitamin d3 supplement, folic acid and calcium iodate.

In an embodiment invention, the dry pet food ingredients 26 may include a nutritional supplement including each of a vitamin e supplement, niacin supplement, calcium pantothenate, riboflavin supplement, biotin, vitamin a supplement, vitamin b12 supplement, thiamine mononitrate, pyridoxine hydrochloride, vitamin d3 supplement, folic acid and calcium iodate.

Still referring to FIG. 2, once the dry pet food ingredients 26 are homogeneously integrated as described above, a portion 28 of ingredients 26 are selected for the incorporation of a flavor additive 30. As was previously described above, in the nonlimiting example of the system 10 in which the container 12 includes four (4) different flavors of dry pet food, 16A-16D, a corresponding four (4) portions 28A, 28B, 28C, and 28D may be selected from the mass dry pet food ingredients 26, to which an individual and different flavor additive 30A, 30B, 30C, 30D are added respectfully. The flavor additive 30A-30D, which may be a natural flavor additive, are then thoroughly mixed and incorporated into the corresponding portion 28A-28D of ingredients 26 from which the four (4) different flavors of dry pet food, 16A-16D, are formed. While it is understood that that the system 10 has been described having four (4) different flavors of dry pet food, 16A-16D, it should be well understood that the present invention is not so limited and that any number of two or more flavors of dry pet food 16, may be considered well within the scope of the present invention.

In an embodiment of the present invention, the flavor additive 30 for incorporation into any given portion 28 of the dry pet food ingredients 26 may be selected from a group including but not limited to beef, cheese, chicken, fish, gravy, and barbecue. In another embodiment, the flavor additive 30 may be selected from a group of flavors including grilled steak, beef pot roast, chicken rotisserie, and honey ham.

Upon incorporation of the flavor additive 30 into the given portion 28 of the dry pet food ingredients 26, the resultant different flavors of dry pet food 16, i.e., kibble, are formed with their respective different flavors. Despite the presence of different flavors, it should be understood that all of the dry pet food 16 within the system 10 retains between 88 and 99 percent by weight, and more preferably between 88 and 94 percent by weight, of the same ingredients.

In an embodiment, all of the dry pet food 16 within the system 10, independent of flavor, retains between 80 and 99 percent by weight, and more preferably between 88 and 94 percent by weight, of the same nutritional content.

In one embodiment, the dry pet food 16, independent of flavor, has one or more of: Protein (min) between 25 wt % to 35 wt % and preferably 30.0 wt %; Fat (min) between 11 wt % to 21 wt % and preferably 16.0 wt %; Total Carbohydrates' (max) between 29 wt % and 39 wt % and preferably 34.0 wt %; Dietary Fiber (max) between 0.1 wt % and 10 wt % and preferably 5.0 wt %; Dietary Starch (max) between 22 wt % and 32 wt % and preferably 27.0 wt %; Sugars (max) between 0.1 wt % and 7 wt % and preferably 2.0 wt %; Moisture (max) between 5 wt % and 15 wt % and preferably 10.0 wt %; Glucosamine (min) between 0.4 mg/g to 0.6 mg/g and preferably 0.5 mg/g; and Chondroitin sulfate (min) between 0.2 mg/g and 0.3 mg/g and preferably 0.25 mg/g.

In one embodiment, the dry pet food 16, independent of flavor, has between 400 and 500 and preferably about 460 Calories per cup; between 100 and 175 and preferably about 134 Calories from Protein per cup, between 150 and 200 and preferably about 174 Calories from Fat per cup, between 125 and 175 and preferably about 152 Calories from Carbohydrate per cup of dry pet food 16.

Still referring to FIG. 2, upon incorporation of the flavor additive 30 into the given portion 28 of the dry pet food ingredients 26, the resultant different flavors of dry pet food 16, i.e., kibble, are formed with their respective different flavors. The resultant different flavors of dry pet food 16A-16B are then portioned into independent packages 14A-14D, as was described above.

In the embodiment shown in FIG. 1, the portion of dry pet food 16 contained within each package 14 may be between 5 ounces and 20 ounces, preferably between 10 ounces and 15 ounces, and more preferably between 11 and 13 ounces. Most preferably, each package 14 includes approximately 12 ounces of dry pet food 16, where the term approximately is understood to be generally plus or minus 2%.

The independent packages 14 may be configured to maintain a sealed internal environment for the dry pet food 16 contained therein and promote a shelf-life of approximately between 6 and 18 months. The packages 14 may be formed of walls that are air-tight, water-tight, moisture impermeable, transparent, translucent, and/or opaque. In one embodiment, the packages are formed of a layered laminate or multilayered package, which may be formed of one or more paper layer, plastic layer, and/or metallic foil layer. The package 14 may be formed of a polyethylene or ethylene vinyl alcohol. The package 14 may be formed of virgin, recycled or fully recycled materials. The package 14 may be formed of recyclable, refillable and/or compostable materials. The package 14 may have a closure, such as a resealable closure integrated into a sidewall of the package. In an alternative, the package 14 may be integral with the container 12 and include partitions or alternative dividers 42 to define the dry pet food 16 storage directly integrated into the container 12.

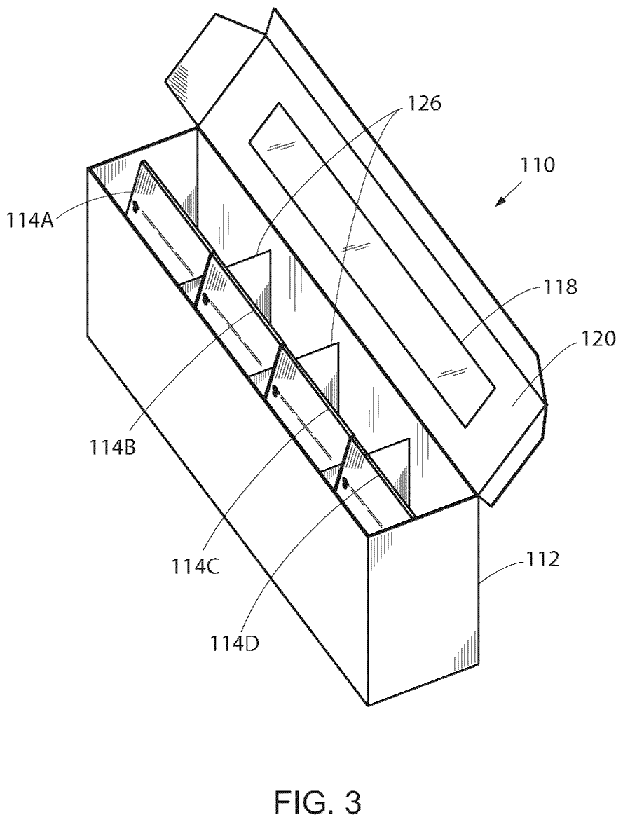

FIG. 3 depicts another embodiment of a packaged dry pet food system 110 constructed in accordance with the present invention. The system includes a container 112, such as a box, which is suited for retail sale. The container contains a plurality of independent packages 114 of dry pet food. As described above, a plurality of flavors of dry pet foods are provided. The plurality of flavors of dry pet food may be provided in the same manner as is described for the packaged dry pet food system 10 shown in FIGS. 1 and 2. Each of the plurality of flavors of dry pet food are contained within the plurality of independent packages 114 that correspond to their respective flavor of dry pet food, identified herein as reference number 114A, 114B, 114C, 114D. In other words, each package 114A, 114B, 114C, 114D shown in FIG. 3 contains a dry pet food having a different flavor but maintaining between 80 to 99 percent by weight of the same ingredients and an equal percentage by weight of a protein.

The container 112 may include an indicum 118 on the inner surface 120 of the container 112, identifying the location of the different flavors. The individual packages 114A, 114B, 114C, 114D may also include a separate indicum (not shown) on the external surface of the packages 114A, 114B, 114C, 114D. The system 110 may also include dividers 126 to separate each package 114 in the container 112.

The portion of dry pet food contained in each package shown in FIG. 3 may be between 1 pound and 7 pounds, or more typically, from 4 pounds to six pounds.

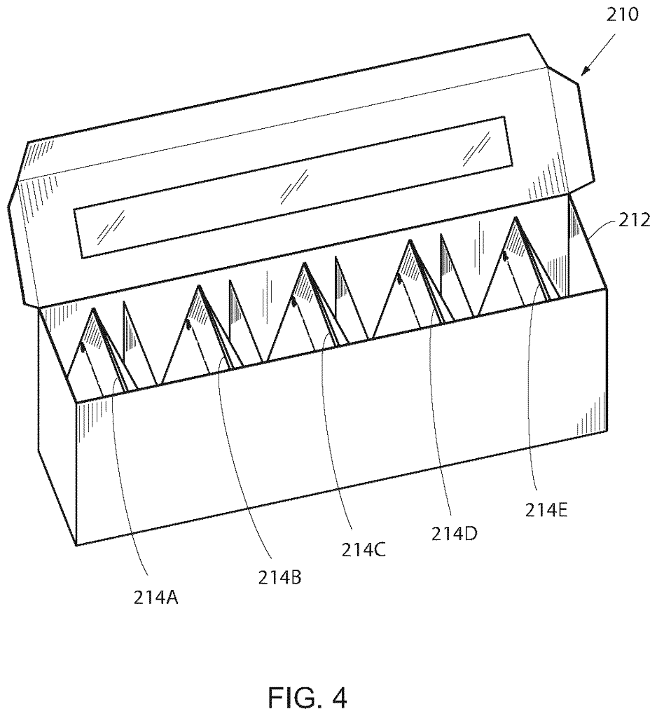

It should be understood that the system 110 shown in FIG. 3 may be modified to contain anywhere from two or more packages containing different flavors of dry pet food. For example, FIG. 4 depicts another system 210, which includes a container 212 that contains five separate packages 214A, 214B, 214C, 214D, 214E of dry pet food. The dry pet food having different flavors while retaining at least between 80 and 99 percent by weight of the same ingredients.

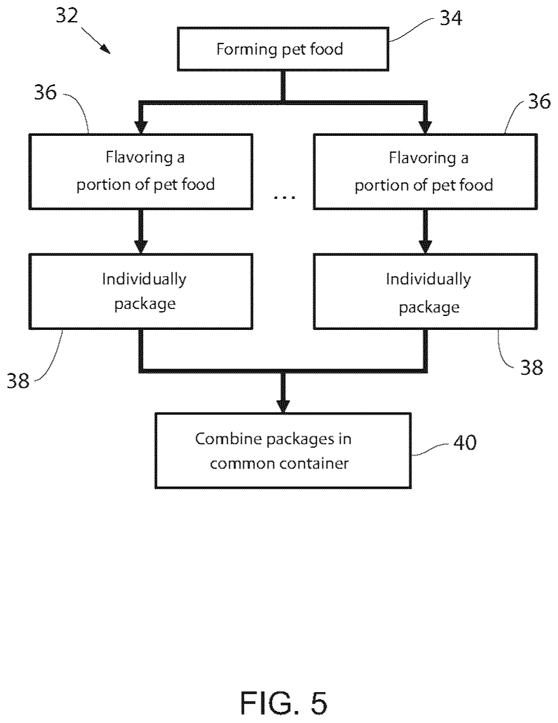

Turning now to FIG. 5 the method 32 of manufacturing the system 10 is shown. At initial step 34, the dry pet food ingredients 26 are combined and homogenously integrated as was described above. At subsequent box 36, portions of the dry pet food mix 26 are combined with flavor additives 30 to provide portions of the dry pet food mix 26 with different flavors to form the resultant different flavors of dry pet food 16, i.e., kibble, while retaining between 80 and 99 percent by weight, and more preferably between 88 and 94 percent by weight, of the same ingredients and/or nutritional content. At subsequent step 38, the different flavors of dry pet food 16 are then portioned into independent packages 14, as was described above. At final step 40, a plurality of each of the independent packages 14 of different flavors of dry pet food 16 are combined into a common container 12. As shown in FIG. 1, a single container 12 may include six (6) packages 14 of each of the different flavors of dry pet food 16. However, it should be understood that the present invention is not limited to such a number, and that any number of packages 14 of different flavored dry pet food 16 may be included in the container 12. Furthermore, while method 32 described above indicated the preparation of a bulk of dry pet food ingredients 26 at step 34, it should be understood that subsequent portioning at step 36 may include the totality of the dry pet food ingredients 26 at step 34 such that an independent batch of dry pet food ingredients 26 at step 34 is prepared for the manufacture of each different flavor of dry pet food 16.

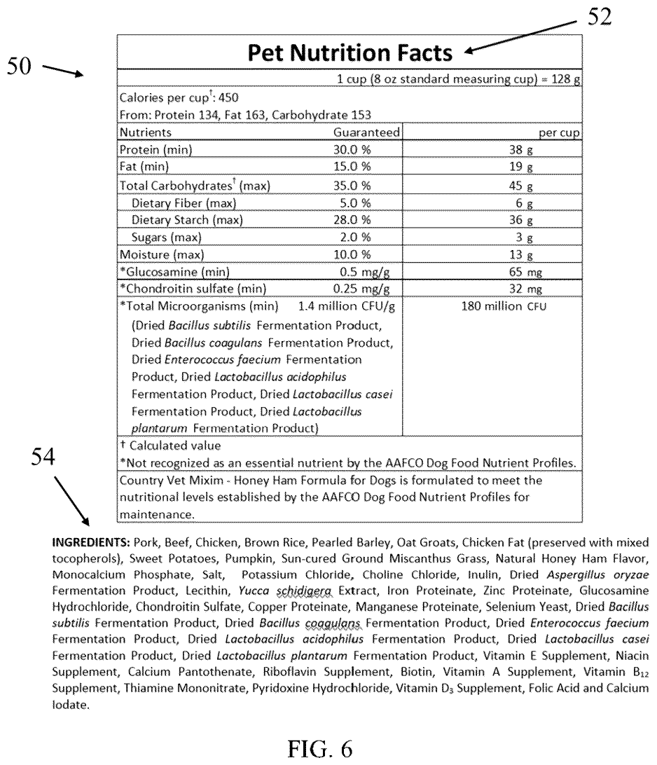

Referring now to FIG. 6, each package 14 of the inventive system 10 may include a nutritional label 50. FIG. 6 depicts an exemplary nutritional label 50 for a package 14 containing a Honey Ham flavor additive 30. Each nutrition label may include nutrition facts 52 and an ingredients panel 54. In this configuration, the animal proteins are identified at the top of the ingredient panel 54. Due to the similarities in ingredients in each package 14 within a container 12, the nutritional facts 52 and the ingredient panel 54 between each package 14 are nearly identical, having only a few differences based on the flavor additive 30 contained in the package 14.

Various configurations of the present invention are contemplated, including all configurations disclosed in Appendix A, which includes exemplary images of the packages and container and exemplary nutritional labels.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. A pet food system configured to lessen irritation of a pet's digestive tract comprising:
a first naturally flavored dry pet food;
a first package for holding at least one cup of the first naturally flavored dry pet food;
a second flavored dry pet food made up of between 80 to 99% of the same ingredients as the first naturally flavored dry pet food;
a second package for holding at least one cup of the second flavored dry pet food;
a container containing the first package and the second package and having an ingredient panel.

2. The pet food system of claim 1 further comprising animal protein inclusions within the dry pet foods having equal value so as to appear on a top of the list on the ingredient panel; and at least one of beef, pork, chicken, fish, gravy, and barbeque contained within the animal protein inclusions.

3. The pet food system of claim 1, wherein the dry pet food includes at least one of the following flavors beef, cheese, chicken, fish, gravy, and barbecue.

4. The pet food system of claim 1, further comprising
a third flavored dry pet food made up of between 80 to 99% of the same ingredients as the first pet food;
a third package for holding at least one cup of the third flavored dry pet food;
a fourth flavored dry pet food made up of between 80 to 99% of the same ingredients as the first pet food; and
a fourth package for holding at least one cup of the fourth flavored dry pet food,
wherein the container contains the third package and the fourth package.

5. The pet food system of claim 4, wherein the container is designed to contain four rows of six 12-ounce sealed packages within the container.

6. The pet food system of claim 5, wherein the container has a flip up lid having a billboard presentation identifying a flavor of each of the dry pet foods.

7. The pet food system of claim 6, wherein the billboard presentation includes a panel for each flavor corresponding to a package holding the flavor indicated.

8. The pet food system of claim 7, wherein the panel comprises a description of each of the flavors.

9. The pet food system of claim 4, wherein the container comprises at least four separate areas, wherein each of the at least four separate areas contain at least one of the four packages of each of the dry pet foods.

10. The pet food system of claim 1, wherein the packages are reuseable and resealable.

11. The pet food system of claim 1, wherein the packages are less than 12 ounces and are reuseable and resealable.

12. The pet food system of claim 1, wherein the packages are from 1 pound to 7 pounds.

13. The system of claim 1 wherein each dry pet food further comprises: Brown Rice, Pearled Barley, Oat Groats, Bacon Fat (preserved with mixed tocopherols), Sweet Potatoes, Pumpkin, and Sun-cured Ground Miscanthus Grass.

14. A container having a plurality of individual packages of dry pet food;
wherein the dry pet food contained within each of the individual packages comprises between 80 to 99 percent by weight of the same ingredients and an equal percentage by weight of an animal protein;
a first package of the plurality of individual packages contains a dry pet food of a first flavor; and,
a second package of the plurality of individual packages contains a dry pet food of a second flavor that is different from the first flavor.

15. The container of claim 15, wherein each individual package comprises from 10 ounces to 7 pounds of dry pet food.

16. The container of claim 16, wherein each individual package is formed of an airtight package wall.

17. The container of claim 14, further comprising a third package of the plurality of individual packages containing a dry pet food of a third flavor that is different from the first and second flavor; and a fourth package of the plurality of individual packages containing a dry pet food of a fourth flavor that is different from the first, second and third flavors.

18. A method of manufacturing a packaged dry pet food system comprising the steps of:
forming a dry pet food having an equal percentage by weight of an animal protein;
flavoring at least a first portion of the dry pet food with a first flavor and at least a second portion of the dry pet food with a second flavor, while maintaining between 80 to 99 percent by weight of the same ingredients between the first and second portions;
packaging the first portion of the dry pet foods into a first package containing only the dry pet food with the first flavor;
packaging the second portion of the dry pet foods into a second package containing only the dry pet food with the second flavor;
combining the first package containing only the dry pet food with the first flavor and the second package containing only the dry pet food with the second flavor into a common retail container, such that the container includes a plurality of dry pet food flavors while maintaining between 80 to 99 percent by weight of the same ingredients between all dry pet food.

19. The method of claim 18, wherein the step of forming the dry pet food includes adding one or more additional ingredients selected from the group consisting of: Brown Rice, Pearled Barley, Oat Groats, Bacon Fat (preserved with mixed tocopherols), Sweet Potatoes, Pumpkin, and Sun-cured Ground Miscanthus Grass.

20. The method of claim 18, further comprising
flavoring a third portion of the dry pet food with a third flavor and a third portion of the dry pet food with a third flavor, while maintaining between 80 to 99 percent by weight of the same ingredients between the portions;
packaging the third portion of the dry pet foods into a third package containing only the dry pet food with the third flavor;
packaging the fourth portion of the dry pet foods into a fourth package containing only the dry pet food with the fourth flavor;
combining the third package containing only the dry pet food with the third flavor and the fourth package containing only the dry pet food with the fourth flavor into the common retail container.
